(19) United States
(12) Patent Application Publication
(10) Pub. No.: US 2008/0171303 A1
(43) Pub. Date: Jul. 17, 2008

(54) Oral rehydration device

(76) Inventors: Howard Roberts, Buffalo Grove, IL (US); Matthew Meyer, Greenfield, WI (US); Maggie Berger, Appleton, WI (US); Christopher Herskovits, Highlands Ranch, CO (US); Slade Stratton, Oklahoma City, OK (US); Carla Thompson, Chicago, IL (US)

Correspondence Address: NAVAL MEDICAL RESEARCH CENTER;ATTN: (CODE 00L), 503 ROBERT GRANT AVENUE, SILVER SPRING, MD, 20910-7500, US

(21) Appl. No.: 11/586,744

(22) Filed: Oct. 12, 2006

(51) Int. Cl. A61C 13/00

(52) U.S. Cl. 433/167

(57) ABSTRACT

The invention relates to an oral rehydration device for the treatment of xerostomia. The device delivers fluid, from an external reservoir, passively, directly to a patient. No human activity is required to provide hydration. The device is capable of operating in a number of clinical and hospital settings, but also in the home environment, where extended treatment of xerostomia is required.

### BACKGROUND OF INVENTION

1. Field of the Invention

The current invention relates to a device capable of passive delivery of rehydration fluid for extended treatment of xerostomia.

2. Description of Related Art

Dry mouth, xerostomia, is an abnormal reduction in saliva production and can be the result of diseases of the salivary glands, radiation of the head and neck, adverse medication effects, and chemotherapy. Dry mouth can affect mouth comfort, oral health, chewing ability, swallowing, speaking, and overall quality of life. Currently, temporary solutions exist to alleviate dry mouth discomfort such as, chewing sugar-free gum, saliva substitutes, sipping water regularly, dietary changes, and medications. However, they only provide temporary relief, require regimented patient compliance, and some have associated side effects.

A number of intra-oral devices to alleviate this malady have been described in the literature. For example, Kam et al. (Clin. Oral Invest. 9:148-153 (2005)) discloses a device consisting of a base plate that attaches to the patients upper pallet containing a fluid filled reservoir gaited by a metal ball valve, and a second device published by Frost et al. consisting of a formed thermoplastic attaching to the upper pallet containing a fluid filled reservoir (Frost, et al., British Dental Journal 193:403-408 (2002)). Both devices improved patient's oral comfort but required active user participation to release the lubricating fluid. Additionally, a number of devices have been disclosed for intra-oral lubricating devices including: Molinoff, Pat. No. 4,917,674 issued April 1990; Jenkins, Pat. No. 5,055,108 issued October 1991; Hoops, Pat. No. 3,991,471 issued November 1976 and Molinoff, Pat. No. 4,838,882 issued June 1989. Except for the 5,055,108 patent, these devices rely on saturated matrixes, such as sponges or foams, to maintain oral moisture. The 5,055,108 patent contains a pallet reservoir and two apertures, one for filing, the second containing a valve responsive to tongue movement for releasing the lubricating fluid. Other forms of xerostomia treatment rely on medications, saliva substitutes, gums, and candies. The common attribute to all of these methods, however, is that they require human action for release of the lubricating fluid. Therefore, a need exists for a passive xerostomia treatment device.

### SUMMARY OF INVENTION

An aspect of the current invention is a passive treatment device for xerostomia by passively providing fluid to a patient's mouth from an external reservoir.

Another aspect of the invention is the passive delivery of fluid for the treatment of xerostomia for extended periods in excess of 8 hours.

An additional aspect of the invention is a pump that provides pressure to passively pump water into the mouth. The pump regulates and meters the flow rate of fluid into the mouth such that no human interaction is necessary for delivery of oral rehydration to the patient's mouth. The pump is capable of providing fluid at a rate similar to the normal production or at other flow rates based on the patient's needs.

Another aspect of the invention is an interface that can be positioned in the patient's mouth without irritating the soft tissues of the mouth. The interface is held in place on the patient by an earpiece that fits around the patient's ear and securely anchors the interface and prevents the interface from moving from the desired location.

### BRIEF DESCRIPTION OF DRAWINGS

FIG. 1. Interrelationships of components of inventive oral rehydration device.

FIG. 2. Diagrammatic representation of interface.

### DESCRIPTION OF THE PREFERRED EMBODIMENTS

The current invention relates to a device for treating xerostomia by delivering rehydrating fluid directly into a patient's mouth. The device does not require human activity for rehydration but rather delivers the desired fluid passively from a reservoir to an interface placed in the patient's mouth. A pump that also meters and regulates the flow rate of fluid into the patient's mouth supplies positive pressure. The device is capable of delivering any type of fluid deemed necessary, including water, mouthwash, toothpaste, and salt solutions.

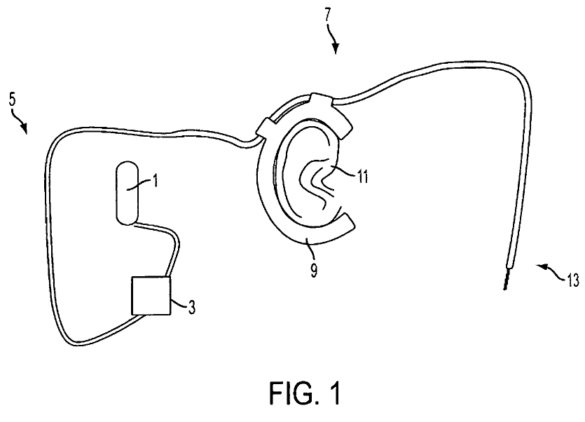

The inventive device consists of four major components: a reservoir, pump interface and earpiece. FIG. 1 illustrates the interrelationships between the components. The reservoir (1), containing water or other rehydration fluid, is located outside of the mouth in order to hold a sufficient volume of fluid to provide adequate fluid to the patient for approximately at least 8 hours without a refill. The reservoir may be an IV bag, tank or other device capable of holding an adequate supply of fluid.

A pump (3) supplies pressure for delivery of fluid to the patient. The pump can be an infusion or other type of device capable of supplying adequate positive pressure to deliver fluid to the patient. The pump has a variable flow-rate setting such that it can be set at a number of desired flow rates to meet the patient's needs including regulating delivery of fluid at a flow-rate that simulates normal salivary production of 0.1 ml/min. Delivery of the fluid to the patient from the reservoir, via the pump, is through a tube (5) from that connects to an interface (7). The interface is held in place by an earpiece (9) that fits over the ear (11). The earpiece is made of any number of materials, including rubber, urethane or silicone, that are nonirritating to skin, is biocompatible, i.e., safe for contact with human food products, but that are stiff enough to provide support to the interface. Fluid is deposited into the patient's mouth via a mouth piece (13).

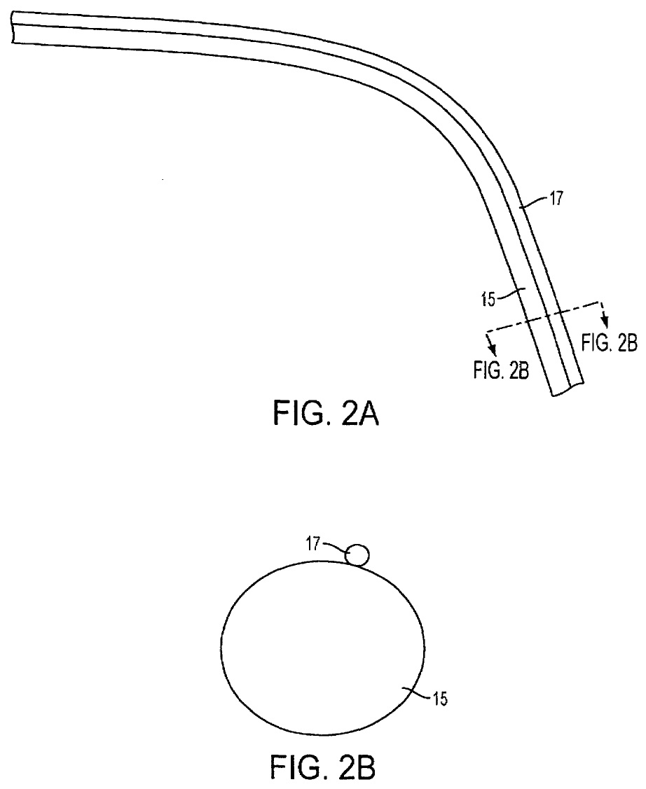

Referring to FIG. 2, the interface is comprised of a hollow tube (15), containing rehydration fluid, and an embedded wire or other material (17). FIG. 2A illustrates that the wire (17) runs longitudinally along the length of the hollow tube. FIG. 2B further illustrates that the wire (17) is connected outside of the tube but is embedded to prevent contact of the wire with the patient, providing added comfort to the patient. The wire provides pliability to the tube, enabling the tube to be bent and placed as desired in the patient's mouth. The metal wire permits positioning of the mouth piece (13) in the patient's mouth comfortably in order to maximize hydration without irritating soft tissue. FIG. 2B illustrates that the

In a preferred embodiment the tube carrying fluid to the interface is made of silicone or other plastic such as polycarbonate or polypropylene that is biocompatible, i.e., safe for contact with food products destined for human consumption. In the preferred embodiment, the non-metal components of the interface will also be made of materials safe for contact with human food products, such as silicone, polycarbonate or polypropylene. The embedded wire of the interface is galvanized steel or other pliable material. The wire is encapsulated onto the outside of the interface so as to prevent the wire from contacting the patient. Connection of the tube to the interface and the tip to the interface are made by any number of adhesives that are biocompatible and safe for use in human medical devices.

What we claim is:

1. An oral rehydration device comprising an interface having a hollow tube connected longitudinally to a stiffening member so that an end of said tube can be positioned in a patient's mouth such that fluid flowing through said interface is deposited into said patient's mouth.

2. The oral rehydration device of claim 1, wherein said stiffening member is a wire.

3. The oral rehydration device of claim 1, wherein said end of said tube contains a tip such that fluid flowing through the tube passes out through said tip.

4. The oral rehydration device of claim 1, wherein said stiffening member is embedded in the material comprising the interface.

5. The oral rehydration device of claim 1, wherein said interface is operably connected via a hollow tube to a reservoir.

6. The oral rehydration device of claim 1, wherein said interface is attached to an earpiece such that the interface is secured via said earpiece to said patient.

7. The oral rehydration device of claim 5, wherein said reservoir is operably connected to said interface via a pump such that fluid flows from the reservoir to the interface via said pump.

8. The oral rehydration device of claim 6, wherein said interface, earpiece and hollow tube are made of biocompatible materials.

9. The oral rehydration device of claim 7, wherein said pump is capable of operation at variable flow rates from 0.01 ml/min to 1.0 ml/min.

10. The oral rehydration device of claim 8, wherein said interface and earpiece are made of one or more biocompatible materials selected from the group consisting of rubber, urethane or silicone.

11. The oral rehydration device of claim 8, wherein said hollow tube is made of polycarbonate or polypropylene.
